(19) United States
(12) Patent Application Publication
(10) Pub. No.: US 2004/0094974 A1
(43) Pub. Date: May 20, 2004

(54) Door handle for vehicles

(76) Inventor: Jai Bong Song, Siheoung-si (KR)

Correspondence Address: MORGAN, LEWIS & BOCKIUS, LLP., 3300 HILLVIEW AVENUE, PALO ALTO, CA, 94304, US

(21) Appl. No.: 10/447,355

(22) Filed: May 28, 2003

(30) Foreign Application Priority Data
Nov. 16, 2002 (KR) 2002-71407

(51) Int. Cl. E05B 3/00

(52) U.S. Cl. 292/336.3

(57) ABSTRACT

The present invention relates to a door handle for vehicles which enables a driver and passengers in a car to unlock a door lock by gripping a grip and pushing a press button formed in a handle cover in the vicinity of the grip with one hand only.

### FIELD OF THE INVENTION

The present invention relates to a door handle for vehicles and more particularly to a door handle that enables a driver and passengers in a car to release the door lock by gripping the handle to get out of the car.

### BACKGROUND OF THE INVENTION

In general, doors for vehicles are divided into rotary vehicle doors and sliding vehicle doors. Rotary doors are usually connected to the body of the car by hinges and opened or closed by the rotation thereof around the hinges. Most automobiles including passenger cars adopt such rotary doors. On the other hand, sliding vehicle doors are opened or closed by sliding movement thereof in parallel with the body of the vehicle.

In the inside of each door, a locking lever connected to the door operating mechanism, e.g., a door lock mechanism, is provided and also a door handle is provided so that the driver and passengers in the vehicle can apply force to the door handle in the direction of opening the door.

However, in the above-mentioned conventional doors, as the locking lever and the door handle were separately installed in the inside of the door, the passenger must operate the locking lever to unlock the door operating mechanism with one hand and grip the handle to apply force in the direction of opening the door with the other hand in order to simultaneously unlock and open the door.

Alternatively, in order to open the door, the passenger must operate the locking lever to unlock the door operating mechanism and then grip the handle to apply force in the direction of opening the door. Therefore, it would be more convenient to open the door by unlocking the door operating mechanism simultaneously with applying force to the handle with one hand.

### SUMMARY OF THE INVENTION

The present invention provides a door handle for vehicles which enables a driver and passengers to open the door by unlocking the door operating mechanism simultaneously by applying force to the handle with one hand. The present invention thus provides a door handle for vehicles which is more convenient and has higher utility than the conventional door handles.

One embodiment of a door handle for vehicles according to the present invention comprises a handle cover having a slide hole in its upper part and a grip below the slide hole. A handle cover panel is fixed in the rear of the handle cover. An arm is provided in the upper part of the handle cover panel, with the upper end of the arm being rotated around a pivot. A cable, which goes up and down according to the rotary state of the arm, switches the door lock on and off. A press button is provided to reciprocate in the slide hole to rotate the arm and ascend/descend the cable. A button guide returns the press button in the slide hole to its original non-pressed position by the elasticity of a restoring spring after the press button is pressed into the slide hole.

In order to open the door utilizing a handle according to an embodiment of the invention, a driver or a passenger grips the grip formed in the handle cover with one hand and pushes the press button in the slide hole with one finger of the hand. Then, as the press button is pressed into the inside of the slide hole, the arm rotates centering around the pivot, and the cable is lifted upward to unlock the door lock. Therefore, doors of an automobile can be opened by using one hand and the utility of doors can be improved.

In an alternative embodiment of the present invention, a handle member defines an opening for receiving a push button. The handle member and push button are configured and dimensioned to permit single handed, simultaneous pulling of the handle member and depression of the push button. A first linkage member is mounted behind the handle member and push button. The first linkage member has a first end pivotably mounted at a point fixed with the handle member and a second end acted on by the push button. A lock actuating cable is operatively connected to the first linkage member for actuation of a locking mechanism in response to depression of the push button. A second linkage member is mounted behind the handle member and push button. The second linkage member is pivotably mounted at a second point fixed with the handle member and resiliently biased to act on the push button in a direction opposed to the depression of the push button. Preferably, the push button has a rear surface defining a concave portion and the first linkage member has an end received in the concave portion. More preferably the door handle further includes a roller mounted on the end received in the concave portion.

### BRIEF DESCRIPTION OF THE DRAWINGS

The accompanying drawing, which is included to provide a further understanding of the invention and is incorporated in and constitutes a part of this specification, illustrates an embodiment of the invention and together with the description serves to explain the principles of the invention, wherein:

FIG. 1 is a sectional view showing the structure of a door handle for vehicles according to an embodiment of the present invention.

### DETAILED DESCRIPTION OF THE PREFERRED EMBODIMENTS

Reference will now be made in detail to preferred embodiments of the present invention in conjunction with the accompanying drawing.

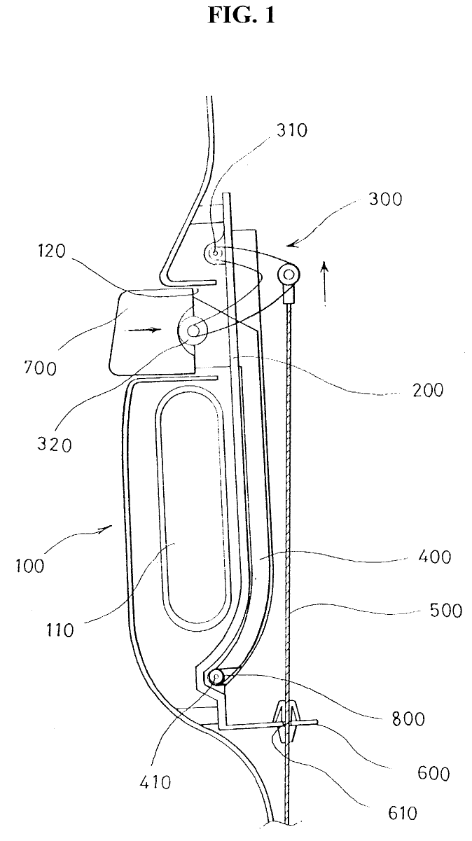

As shown in FIG. 1, an embodiment of a handle cover 100 defines a slide hole 120 in its upper part and a grip 110 below the slide hole. A handle cover panel 200 is fixed in the rear of the handle cover 100. An arm 300 is provided in the upper part of the handle cover panel 200, with the upper end of the arm 300 being rotatable centering around a pivot 310. A cable 500, which goes up and down according to the rotary state of the arm 300, switches the door lock (not shown) on and off. A press button 700 is provided to reciprocate in the slide hole 120 to rotate the arm 300 and ascend/descend the cable 500. A button guide 400 returns the press button 700 in the slide hole 120 to its original non-pressed position by the elasticity of a restoring spring 800 after the press button 700 is pressed into the slide hole 120.

At the lower end of the arm 300, a roller 320 is provided to be in contact with the rear of the press button 700. The middle part of the arm 300 is connected to the upper end of the cable 500, one end of which is connected to the door lock. A guide panel 600 is provided at the lower end of the handle cover panel 200 to guide the cable 500 and allow the cable 500 to smoothly ascend and descend through a guide hole 610. After the press button 700 is pressed into the slide hole 120 to open the door, the button guide 400 returns the press button 700 to its original non-pressed position by the elasticity of the restoring spring 800. Preferably, the button guide 400 is integrally formed with the press button 700.

When the press button 700 is returned to its non-pressed position by the button guide 400, it projects outside of the slide hole 120 to the extent that the front part of the button guide 400 abuts on the rear of the handle cover panel 200.

The button guide 400 is installed to be rotatable around a hinge 410 at its lower end behind the handle cover panel 200.

As described above, according to an embodiment of the present invention, the handle cover panel 200 is fixed on the rear of the handle cover 100 including the grip 110, and one end of the arm 300 is connected to the upper end part of the handle cover panel 200 to be rotatable around the pivot 310. At the lower end of the handle cover panel 200 the guide panel 600 is extended and has the guide hole 610 through which the cable 500 ascends and descends.

Further, the press button 700 is installed in the slide hole 120 and after being pressed into the slide hole 120, it returns to its original position by the restoring spring 800 of the button guide 400, the lower end of which is rotated around the hinge 410.

Therefore, in opening the door of vehicles, a driver or a passenger can push the press button 700 in the slide hole 120 with one finger of one hand, while gripping the grip 110 formed in the handle cover 100 with the same hand. Then, as the press button 700 is pressed into the inside of the slide hole 120, the arm 300 rotates centering around the pivot 310, and the cable 500 is lifted upward to unlock the door lock through the guide hole 610 of the guide panel 600.

After the press button 700 is pushed into the slide hole 120, it returns to its original position by the elasticity of the recovering spring 800 fitted to the button guide 400, the lower end of which is rotated around the hinge 410.

As mentioned above, according to the present invention, the door handle comprising the grip and the press button in the vicinity of the grip enables a driver or a passenger to open doors of an automobile by gripping the grip and pushing the press button with one hand. Therefore, doors of an automobile can be open by using one hand and the utility of doors can be improved.

It will be apparent to those skilled in the art that various modifications and variations can be made to the present invention without departing from the spirit and scope of the invention. The present invention covers the modifications and variations thereof provided they come within the scope of the appended claims and their equivalents.

What is claimed is:

1. A door handle for vehicles comprising:
a handle cover defining a slide hole in an upper part and a grip below the slide hole;
a handle cover panel fixed behind the handle cover;
an arm provided in the upper part of the handle cover panel, with the upper end of the arm being rotatable around a pivot;
a cable activated by the arm to switch on and off a door lock;
a press button provided to reciprocate in the slide hole to rotate the arm; and
a button guide to return the press button in the slide hole to an original non-pressed position by the elasticity of a restoring spring after the press button is pressed into the slide hole.

2. The door handle as claimed in claim 1, wherein a roller is provided at the lower end of the arm to be in contact with the rear of the press button, and the middle part of the arm is connected to the upper end of the cable, one end of which is connected to the door lock.

3. The door handle as claimed in claim 1, wherein a guide panel is provided at the lower end of the handle cover panel to guide the cable and allow the cable to smoothly ascend and descend through a guide hole in the panel.

4. The door handle as claimed in claim 1, wherein after the press button is pressed into the slide hole to open the door, the button guide integrally formed with the press button returns the press button to its original non-pressed position by the elasticity of the restoring spring.

5. The door handle as claimed in claim 1, wherein when the press button returns to its non-pressed position projecting to the outside of the slide hole to the extent that the front part of the button guide abuts on the rear of the handle cover panel.

6. The door handle as claimed in claim 1, wherein the button guide is installed to be rotatable around a hinge at its lower end behind the handle cover panel.

7. A door handle for vehicles, comprising:
a handle member defining an opening;
a push button received in said opening, said handle member and push button being configured and dimensioned to permit single handed, simultaneous pulling of the handle member and depression of the push button;
a first linkage member mounted behind the handle member and push button, said first linkage member having a first end pivotably mounted at a point fixed with the handle member and a second end acted on by said push button;
a lock actuating cable operatively connected to said first linkage member for actuation of a locking mechanism in response to depression of said push button; and
a second linkage member mounted behind the handle member and push button, said second linkage member being pivotably mounted at a second point fixed with the handle member and resiliently biased to act on said push button in a direction opposed to the depression of the push button.

8. The door handle of claim 7, wherein said push button has a rear surface defining a concave portion and said first linkage member has an end received in said concave portion.

9. The door handle of claim 8, further comprising a roller mounted on said end received in said concave portion.
